(19) United States
(12) Patent Application Publication
(10) Pub. No.: US 2012/0213416 A1
(43) Pub. Date: Aug. 23, 2012

(54) METHODS AND SYSTEMS FOR BROWSING HETEROGENEOUS MAP DATA

(75) Inventors: Eli Dylan LORIMER, San Francisco, CA (US); Henrik Bentel, San Francisco, CA (US); Lin Kuang, Milpitas, CA (US); Mark Damon Wheeler, Monte Sereno, CA (US); Matthew Robert Simpson, San Francisco, CA (US)

(73) Assignee: GOOGLE INC., Mountain View, CA (US)

(21) Appl. No.: 13/310,307

(22) Filed: Dec. 2, 2011

Related U.S. Application Data
(60) Provisional application No. 61/445,866, filed on Feb. 23, 2011.

(51) Int. Cl. G06K 9/00

(52) U.S. Cl. 382/113

(57) ABSTRACT

Methods, systems and articles of manufacture for browsing heterogeneous map data are described herein. A method embodiment includes displaying a plurality of homogeneous images, each image representing a geographic information system (GIS) dataset comprising one or more map assets an enabling browsing of GIS datasets and map assets using said displayed images independent of underlying data formats of said GIS datasets. A system embodiment includes a map data engine configured to receive a plurality of homogeneous images, each image representing a GIS dataset comprising one or more map assets, and a user interface configured to display said images and enable browsing of GIS datasets and map assets using said displayed images independent of underlying data formats of said GIS datasets.

### CROSS-REFERENCE TO RELATED APPLICATION

This patent application claims the benefit of U.S. Provisional Patent Application No. 61/445,866, (Attorney Docket No. 2525.4930000), filed Feb. 23, 2011, entitled “Methods and Systems For Browsing Heterogeneous Map Data,” which is incorporated herein by reference in its entirety.

### FIELD

Embodiments generally relate to visualizing geographically-linked information.

### BACKGROUND

Geographically-linked information, such as information included in geographic information system (GIS) datasets, often comes from different sources and is maintained in different native formats. These native formats are tied to their respective GIS software which is needed to view and perform operations on the geographically-linked information. Because of the wide range of these formats, accessing and manipulating data is complicated and time consuming. Furthermore, as the amount of geographically-linked information in different GIS formats increases, it becomes increasingly difficult to manipulate and disseminate such information to users.

### BRIEF SUMMARY

Embodiments relate to browsing heterogeneous map data. A method embodiment includes displaying a plurality of homogeneous images, each image representing a GIS dataset comprising one or more map assets, and enabling browsing of GIS datasets and map assets using the displayed images independent of underlying data formats of the GIS datasets.

A system embodiment includes a map data engine configured to receive a plurality of homogeneous images, each image representing a GIS dataset comprising one or more map assets, and a user interface configured to display the images and enable browsing of GIS datasets and map assets using the displayed images independent of underlying data formats of the GIS datasets.

Further embodiments, features, and advantages, as well as the structure and operation of the various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a system for browsing heterogeneous map data, according to an embodiment.

FIG. 2 is a flowchart illustrating an exemplary operation of a map data engine and a user interface, according to an embodiment.

FIG. 3 is a flowchart illustrating an exemplary operation for display of map metadata according to an embodiment.

FIG. 4 is a flowchart illustrating an exemplary operation for display of metrics and analytics, according to an embodiment.

FIGS. 5-10 are diagrams illustrating exemplary user interfaces, according to the embodiments.

FIG. 11 illustrates an example computer useful for implementing components of the embodiments.

### DETAILED DESCRIPTION

Embodiments relate to browsing heterogeneous map data. Embodiments enable display of one or more homogeneous images (e.g., thumbnail images), where each image represents a GIS dataset comprising one or more map assets. Each GIS dataset may include one or more files, and each GIS dataset may have an underlying data format or source format. A GIS dataset may include any form of imagery, photography, points of interest data, base-map/vector data, terrain, bathymetry, three dimensional model data and any other form of data or content. Data formats for GIS datasets may include, for example and without limitation, GIS raster formats, vector formats, and grid formats. As an example, each data format may be dependent upon a specific computer platform, and may require certain computer hardware and/or software to access and manipulate the formatted information.

An embodiment enables browsing of GIS datasets and map assets using displayed homogeneous images independent of underlying data formats of the GIS datasets. Homogeneous images may include, for example, images having uniform size and/or shape. For example, the images may have the same file size and/or display dimensions. Homogeneous images may include images in any known image file format such as JPG, PNG, BMP, TIFF, etc. Such images may also be interactive or animated (e.g., animations or video). The embodiment further includes enabling a user to interact with the displayed images and displaying metadata associated with the map assets upon user interaction with the images. The embodiment also includes displaying metrics and analytics related to usage of the map assets and the GIS datasets.

In this way, map builders may conveniently and efficiently browse and manipulate numerous GIS datasets that may have different underlying source or data formats using a user interface that displays homogeneous images representing the datasets.

In an embodiment, the user interface may enable map builders to upload GIS datasets in their respective source formats for translation by the embodiments into a platform independent format. In an embodiment, the translated GIS datasets may be provided to one or more users through client platforms (e.g., two dimensional (2D) and three dimensional (3D) map platforms) and instantiated on various computing devices (e.g., laptop, smart-phone, desktop, etc.).

In an embodiment, a map including one or more translated GIS datasets may be created using the user interface. The map may be published using the user interface to various client platforms on various computing devices through a serving system.

While the present embodiments are described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the embodiments would be of significant utility.

The term “map” as used herein refers to any digital map, any form of geographically linked information and associated metadata. A map may include 2D and 3D representations as well as embedded imagery, audio, video, applications, widgets, etc. These examples are illustrative and are not intended to limit the embodiments.

The term “feature(s)” as used herein may refer to any geographically-linked features displayed on a map. For example, such features may include, but are not limited to, points of interest, terrain features, region boundaries, man made structures, water bodies, etc. The features may also include any user interface features displayed on a map. These examples are illustrative and are not intended to limit the embodiments.

The term “vector data” as used herein may refer to points, lines, and polygons that are used to define a map. Furthermore, vector data may also include any data or metadata (e.g., population, area, latitude, longitude etc.) that is associated with one or more map regions. Vector data may also include roads, lines, GPS tracks and track points, etc. These examples are illustrative and are not intended to limit the embodiments.

The term “map builder” as used herein may refer to any user (e.g., cartographer) who creates and/or modifies a map, or any other geographically linked information. A map builder may also define different map visualizations and map user interface elements using, for example, a map builder client.

The term “published map” as used herein refers to any digital map, any form of geographically linked information and associated metadata that is displayed in entirety or in part for viewing. A published map may include 2D and 3D representations as well as embedded imagery, audio, video, applications, widgets, gadgets, etc. These examples are illustrative and are not intended to limit the embodiments.

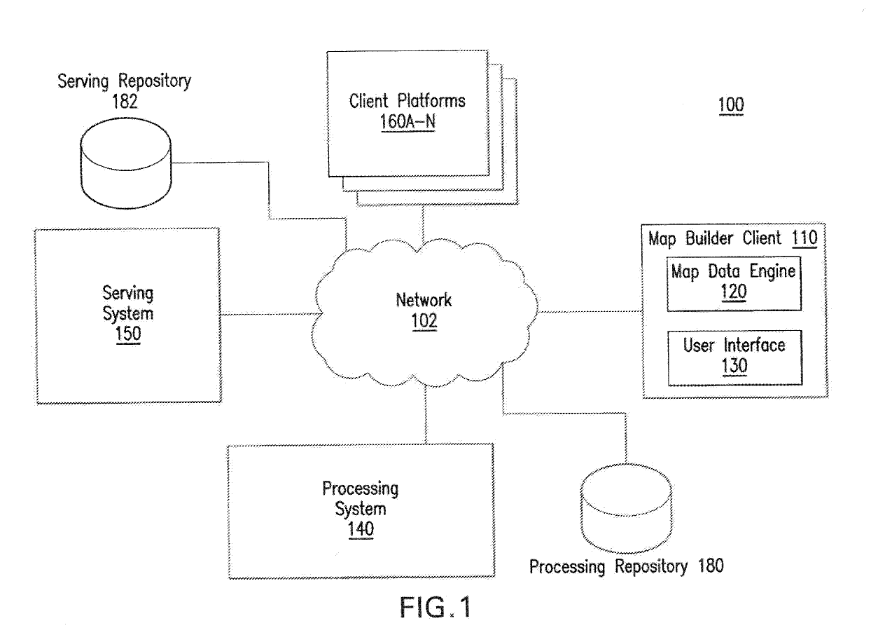

FIG. 1 is a block diagram of system 100 for browsing heterogeneous map data, according to an embodiment. System 100 may include network 102, map builder client 110, processing system 140, processing repository 180, serving system 150, serving repository 182, and a plurality of client platforms 160A-N. Map builder client 110 further includes map data engine 120 and user interface 130.

In an embodiment, user interface 130 may enable one or more map builders (or cartographers) to upload geographically-linked or GIS data in various formats, apply access controls to the data, group the data into maps, author and style maps, and build and publish maps in a platform-independent format to end users at client platforms 160A-N. User interface 130 may also enable map builders to define characteristics of a published map, such as the data that may be included in each layer of the map (e.g., user demographic data, terrain data, etc.), visualization styles that may be applied to different layers of the map, and access controls that may be applied to the map and to different layers of map data.

By accessing user interface 130, map builders (or cartographers) may build and publish platform independent maps and any other geographically-linked information. Published maps may be viewed by one or more users using client platforms 160A-N. In an embodiment, map builders may use user interface 130 to build and publish platform-specific maps. User interface 130 may facilitate various functions, including uploading of GIS datasets, processing of GIS datasets, applying map access controls, and editing geographically-linked information or any other data. User interface 130 may also be configured to display interactive entities (e.g., gadgets and widgets) on a map. Gadgets are further described in U.S. patent application Ser. No. 61/445,861 (Atty. Dkt. No. 2525.4940000), entitled “Cross-Platform Cloud-Based Map Creation,” which is incorporated by reference herein in its entirety.

In an embodiment, map data engine 120 may receive a plurality of homogeneous images, each image representing a GIS dataset comprising one or more map assets. In an embodiment, these homogeneous images may be received from processing system 140. In an embodiment homogeneous images may be uniform thumbnail images (or snapshot overview images, preview images, etc.). In an embodiment, user interface 130 is configured to display the images and enable browsing of GIS datasets and map assets using the displayed images independent of underlying data formats of the GIS datasets.

In an embodiment, users may view geographically-linked information and any associated data through client platforms 160A-N. In an embodiment, each client platform 160A-N may be the same, or a different platform. Such client platforms may be instantiated in a browser or even as standalone software applications. Additionally, client platforms 160A-N may display geographical information in 2D and/or 3D representations.

Network 102 may include one or more networks, including but not limited to, a local area network, medium-area network, and/or wide-area network, such as the Internet. Network 102, for example, may be any form of wired or wireless network that allows map builder client 110, processing system 140, processing repository 180, sewing system 150, serving repository 182, and client platforms 160A-N and any additional clients or servers to communicate with each other.

As noted above user interface 130 enables browsing of GIS datasets and map assets using displayed homogeneous images independent of underlying data formats of the GIS datasets. In this way, map builders can conveniently and efficiently browse and manipulate numerous GIS datasets that may have different underlying source formats using a user interface that displays images representing the datasets. Exemplary user interfaces are described further below.

User interface 130 may also facilitate editing map access security settings, such as through creating or editing an access control list (ACL). An ACL may define one or more users that may be given access to some or all of geographic information stored and/or published by system 100. A user may be assigned to an ACL having a predefined level of access to view, modify and manipulate map data using client platforms 160A-N. Example levels of ACL access may include (basic viewing rights, intermediate viewing privileges and administrator or moderator access privileges). ACLs are further described in U.S. patent application Ser. No. 61/445,883 (Atty. Dkt. No. 2525.4950000), entitled “Object-Based Access Control. For Map Data,” which is incorporated by reference herein in its entirety.

Processing system 140 may receive one or more GIS datasets in their respective source formats from map builder client 110. Each GIS dataset may comprise one or more map assets or map data files. Processing system 140 translates the GIS datasets into a platform independent format and provides the translated GIS datasets and their respective map assets in the platform independent format to one or more client platforms 160A-N using serving system 150. In a non-limiting embodiment, processing system 140 may also translate the GIS datasets into a platform specific format.

In an embodiment, processing system 140 generates one or more homogeneous images (e.g., thumbnail images or screen-shots), where each image represents a GIS dataset comprising one or more map assets. Processing system 140 may then provide the homogeneous images to map data engine 120 and user interface 130 for display. In this way, embodiments enable browsing of GIS datasets and map assets using displayed homogeneous images independent of underlying data formats of the GIS datasets.

Processing system 140 may access information stored on processing repository 180. Processing repository 180 may be a persistent storage device or a device that allows both persistent and transient storage of data. Processing repository 180 may allow processing system 140 to securely store and manage map asset data and associated metadata. In an embodiment, processing repository 180 may store one or more versions of GIS datasets. Any dataset version may be viewed by a map builder in user interface 130. Furthermore, any other (or the same) dataset version may be published by a map builder to clients 160A-N using user interface 130.

In an embodiment, processing system 140 may group each of the one or more translated GIS datasets into a translated asset. Furthermore, for example, a map may include data from different GIS datasets. In an embodiment, these different GIS datasets may be grouped together as a translated asset representing the map, Processing system 140 may track a translated asset and maintain the translated asset as a single entity representing the map. In this way, by maintaining the translated asset as a single entity, a plurality of GIS datasets, may continue to represent the map, independent of operations performed on the map at one or more of user clients 160A-N.

In an embodiment, processing system 140 receives one or more GIS datasets and corresponding map files. Processing system 140 may translate each of the GIS datasets and map files into a platform-independent format, and group the translated files together as a translated asset. Processing system 140 may provide one or more of translated GIS datasets and assets to serving system 150. Serving system 150 may then publish a map including one or more translated GIS datasets. The published map may be a 2D or 3D representation at clients 160A-N. Serving system 150 may access information stored on serving repository 182. Serving repository 182 may be any storage device that stores data needed by serving system 150 to perform data retrieval, map publishing, and forwarding of maps and translated GIS datasets to the client platforms 160A-N.

In an embodiment, a map builder may track and monitor the operation of processing system 140 and serving system 150 using user interface 130. For example, a map builder may be able to check if a GIS dataset has been translated into a platform independent format or is being currently translated into a platform independent format. A map builder may also check, for example, if a GIS dataset has been served to one or more clients 160A-N using serving system 150.

The operation of processing system 140 and serving system 150 is further described in U.S. patent application No. ______ (Atty. Dkt. No. 2525.4940000), entitled “Cross-Platform Cloud-Based Map Creation,” which is incorporated by reference herein in its entirety.

Client platforms 160A-N, map builder client 110, processing system 140 and serving system 150 can each be any type of processing (or computing) device having one or more processors. For example, these device(s) may be a workstation, mobile device (such as a mobile phone tablet or laptop), computer, cluster of computers, set-top box, embedded system, console, or other device having at least one processor. Such a processing device may include software, firmware, hardware, or a combination thereof, Software may include one or more applications and an operating system. Hardware can include, but is not limited to, a processor, memory and graphical user interface display.

In an embodiment, both processing system 140 and/or serving system 150 may be implemented across a plurality of computers. Also, in an embodiment, all processing tasks performed and/or requested by processing system 140, serving system 150, client platforms 160A-N and map builder client 110 may be distributed across a plurality of computers. In this way, embodiments may employ a cloud computing architecture to process, store and provide map data for display.

In an embodiment, user interface 130 may enable a map builder to style maps based on one or more platform independent style sheets. In an embodiment, user interface 130 may enable a map builder to define a map style sheet that includes one or more style rules. Style rules may, for example, define the appearance and behavior of any feature or user interface element that appears on a displayed map. For example, a style sheet rule may specify the color of a set of map features that are displayed at a particular zoom level. Style sheets may also be used to define pop-up window contents when a user clicks on or hovers over a map feature or element. In an embodiment, one or more map style sheets may be applied to map vector data (e.g., points, lines, and polygons) to obtain a styled map layer.

User interface 130 may also enable a user to perform a spatial search on a map displayed in user interface 130. As an example, a map builder (or any user) may draw a polygon (or any other shape) on a map to select a region on the map. This selection may cause user interface 130 to return all datasets that are associated with the selected region of the map.

User interface 130 may also enable a map builder to view a live/interactive preview of map data within a map and/or 3D globe. Such a preview may allow for easier and more thorough inspection of the map data during map creation. For example, a map builder may interactively zoom/pan around a map or 3D globe to inspect data at all levels of system 100, immediately after uploading the data as well as before, during, or after creation of a map or publishing the map to clients 160A-N.

In an embodiment, a map published and being displayed at clients 160A-N may be updated at any time using map builder client 110 and user interface 130. For example, the visualization style of a map and its features may be changed by a map builder at anytime using map builder client 110. For example, a map builder may be able to update a style sheet stored at processing system 140 using user interface 130. Once the style sheet is updated, a corresponding map published and being displayed at clients 160A-N may be updated on-the-fly and responsive to the update. In another example, an access control list associated with a published map may be changed to control access or viewing of the published map at clients 160A-N. Furthermore, additional metadata may be associated with the published map, using user interface 130, as it is being viewed by a user at one or more of clients 160A-N. A published map may also be updated by adding, deleting and/or modifying the individual datasets that are associated with the published map.

Map style sheets are further described in U.S. patent application Ser. No. 61/445,868 (Atty. Dkt. No. 2525.4960000), entitled “Style Sheets For Dynamic Styling Of Platform Independent Map Data,” which is incorporated by reference herein in its entirety.

In an embodiment, any user viewing a published map at clients 160A-N may not experience any viewing or editing interruption while the published map is being updated by a map builder using user interface 130. In another embodiment, while the published map is being updated by the map builder, the user may continue to view the existing version of the published map. Later, upon subsequent access to the published map, the user may view the most current version or updated version of the published map.

In an embodiment, user interface 130 may also enable enabling creation of one or more workspaces. The workspaces may include one or more GIS datasets and map assets from the GIS datasets. For example, a map builder may create a workspace that includes GIS datasets that are more frequently accessed by the map builder. In this way, the map builder can conveniently manipulate such GIS datasets using the workspaces.

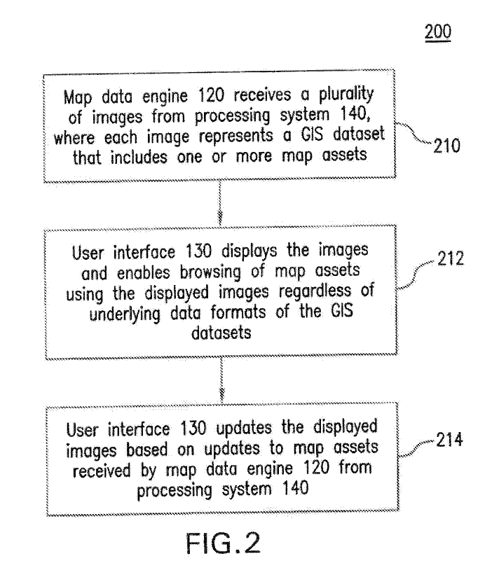

FIG. 2 is a flowchart illustrating an exemplary operation of a map data engine and a user interface, according to an embodiment.

Method 200 begins with map data engine 120 receiving a plurality of images from processing system 140, where each image represents a GIS dataset that includes one or more map assets (step 210).

As an example, images received by map data engine 120 may be uniform thumbnail images. Furthermore, as discussed above, each GIS dataset may be formatted according to an underlying source format, and may include information about one or more locations (e.g., spatial data) and additional information about each location (e.g., map metadata). As an example, each GIS dataset may comprise one or more files. In one embodiment, a GIS dataset may include one file with spatial data, and one or more additional files with attribute data, such as elevation data and shape data.

Source formats for GIS datasets may include, for example and without limitation, raster formats, vector formats, and grid formats. Raster formats may describe geographical features. Implementations of raster formats for GIS datasets may include, for example and without limitation, ARC Digitized Raster Graphics (ADRG), Band Interleaved by Line, Compressed ARC Digitised Raster Graphics, Enhanced Compressed ARC Raster Graphics, Controlled Image Base, Digital raster graphic, enhanced compressed wavelet, ESRI grid, GeoTIFF, ERDAS Imagine image file format, JPEG2000, Multi-Resolution Seamless Image Database, netCDF, etc.

Vector formats may describe geographical features as points, lines, and polygons. Implementations of vector formats for GIS datasets may include, for example and without limitation, Geography Markup Language, AutoCAD DXF, Shapefile, Simple Features, MapInfo TAB format, National Transfer Format, Topologically Integrated Geographic Encoding and Referencing, Cartesian coordinate system, Vector Product Format, GeoMedia, ISFC, Personal Geodatabase, File Geodatabase, Coverage, Spatial Data File, GeoJSON, SOSI_Standard, Digital Line Graph, etc.

Grid formats for GIS datasets may include, for example and without limitation, USGS Digital Elevation Model (DEM), Digital Terrain Elevation Data (DTED), GTOPO30, SDTS, etc.

These examples are purely illustrative and are not intended to limit the embodiments. Embodiments may be configured to work with any GIS or map data format, known now, or developed in the future.

Returning to flowchart 200, user interface 130 displays the images and enables browsing of map assets using the displayed images independent of underlying data formats of the GIS datasets (step 212). As an example, a map builder may be able to view metadata associated with a GIS dataset by clicking on (or hovering over) its respective thumbnail image. As an example, such GIS dataset metadata may include, but is not limited to, time/date of creation, GIS source format information, dataset size, last update date/time, name of data provider, etc. Furthermore, user interface 130 may enable a map builder to share datasets and control access settings of datasets. User interface 130 may also enable a map builder to associate one or more datasets with a map that is to be published at clients 160A-N. For example, user interface 130 may enable information from different datasets to be displayed in separate map layers on map published at clients 160A-N.

User interface 130 updates the images displayed in step 212 based on updates to map assets received by map data engine 120 from processing system 140 (step 214). As an example, the GIS datasets may be updated at their respective data sources, at clients 160A-N or even at map builder client 110. These updates may be reflected in real time and on-the-fly at their respective thumbnail images displayed on user interface 130.

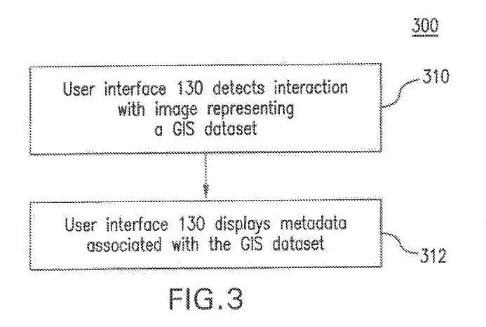

FIG. 3 is a flowchart illustrating an operation for display of map metadata, according to an embodiment.

Method 300 begins with user interface 130 detecting interaction with an image representing a GIS dataset (step 310). As an example, user interface 130 may detect a mouse click event or even a mouse hover over event on one or more images.

User interface 130 displays metadata associated with the GIS dataset (step 312). As an example, such GIS dataset metadata may include, but is not limited to, time/date of dataset creation, dataset source format information, dataset size, last update date/time, name of data provider, etc. In an embodiment, user interface 130 may also enable a map builder to search through metadata of one or more GIS datasets.

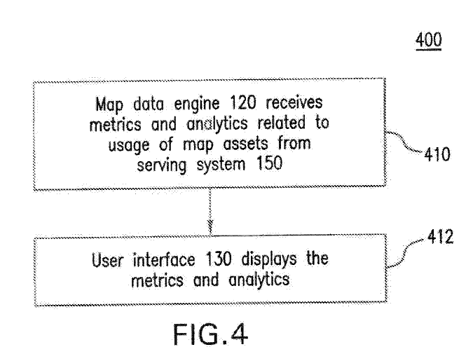

FIG. 4 is a flowchart illustrating an operation for display of metrics and analytics, according to an embodiment.

Method 400 beings with map data engine 120 receiving metrics and analytics related to usage of map assets from serving system 150 (step 410). As an example, such metrics and analytics may include, but are not limited to, dataset views at clients 160A-N, names/identities of dataset viewers, a percentage of increase or decrease in dataset views, etc.

User interface 130 displays the metrics and analytics (step 412). As an example, user interface 130 may display the metrics and analytics received in step 410 in the form of interactive graphs. For example, one graph may display dataset views with respect to time. A user may interact with the graphs by zooming in or out of the graphs or selecting data-points on the graphs. Furthermore, a user may be able to create custom graph representations by selecting metadata and metrics associated with one or more GIS datasets. Exemplary visualizations of dataset metrics and analytics are described further below.

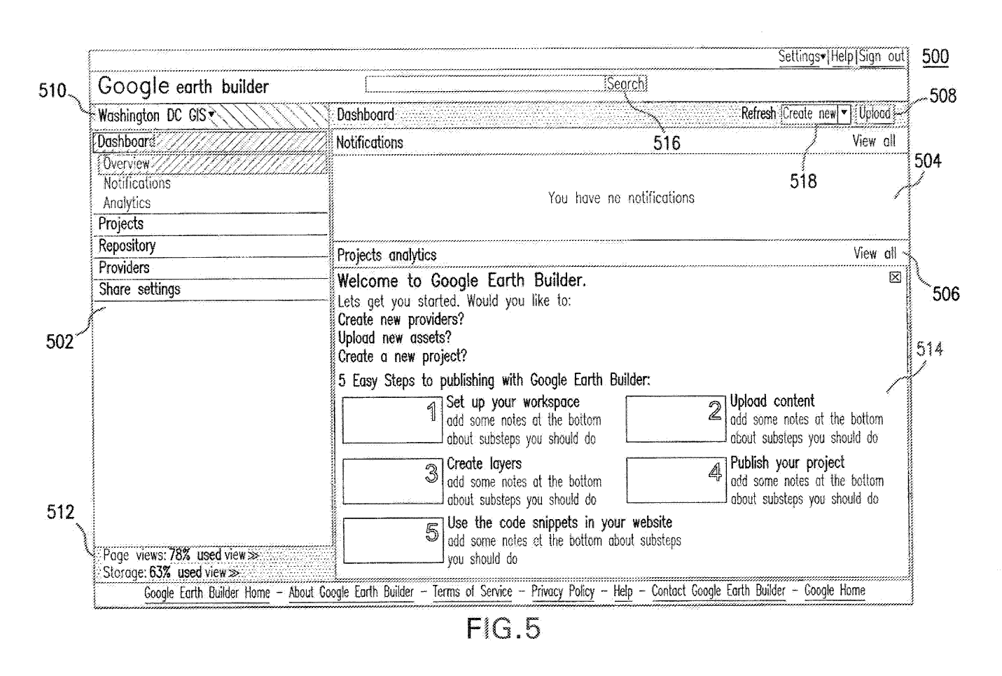

FIG. 5 illustrates an exemplary user interface 500, according to an embodiment. In an embodiment, user interface 500 may be used to initiate or modify a map project. A map project may be used to publish a map to clients 160A-N for display. A map project may be composed of one or more GIS datasets and any associated data.

User interface 500 may include project name 510, menu 502, project statistics 512, start area 514, project analytics area 506, notifications area 504, upload button 508, create button 518 and search box 516.

In an embodiment, project name 510 may be used to display the name of a map project that is being accessed by a map builder using user interface 500. Menu 502 may enable a map builder to display and modify one or more of notifications, projects, repository data, GIS dataset provider data and share settings for a map project.

In an embodiment, project statistics 512 may display one or more statistics associated with a map project (e.g., map project 510). Such statistics may include, but are not limited to, page views and repository storage used by the map project.

In an embodiment, start area 514 enables a map builder to setup a map workspace, upload content to a map project or repository, create map layers, add script code (e.g., JavaScript) to a map and publish one or more maps to one or more clients 160A-N.

In an embodiment, project analytics area 506 may be used to display metrics and analytics related to usage of map assets. An exemplary project analytics area is described further below.

In an embodiment, notifications area 504 may be used to display any messages and alerts related to map project 510 or any other datasets associated with system 100. For example, notifications area 504 may display an alert when one or more GIS datasets are updated at their respective source.

In an embodiment, upload button 508 enables map builders to upload GIS datasets in their respective source formats for translation by the processing system 140 into a platform independent format. As discussed above, the translated GIS datasets may be provided to one or more users through client platforms (e.g., two dimensional (2D) and three dimensional (3D) map platforms) and instantiated on various computing devices (e.g., laptop, smart-phone, desktop, etc.).

In an embodiment, create button 518 may be used to create a new map project. As noted above, a map project may be used to publish a map to user clients 160A-N for display. A map project may be composed of one or more GIS datasets and any associated data. When a new map project is created and opened, the name of the map project may be displayed in map project name 510.

In an embodiment, search box 516 may be used to search GIS datasets and any map related metadata, imagery, video, audio, etc. A map builder may be able to enter any search string to locate and retrieve GIS datasets (and any other map data) that may be of interest to the map builder.

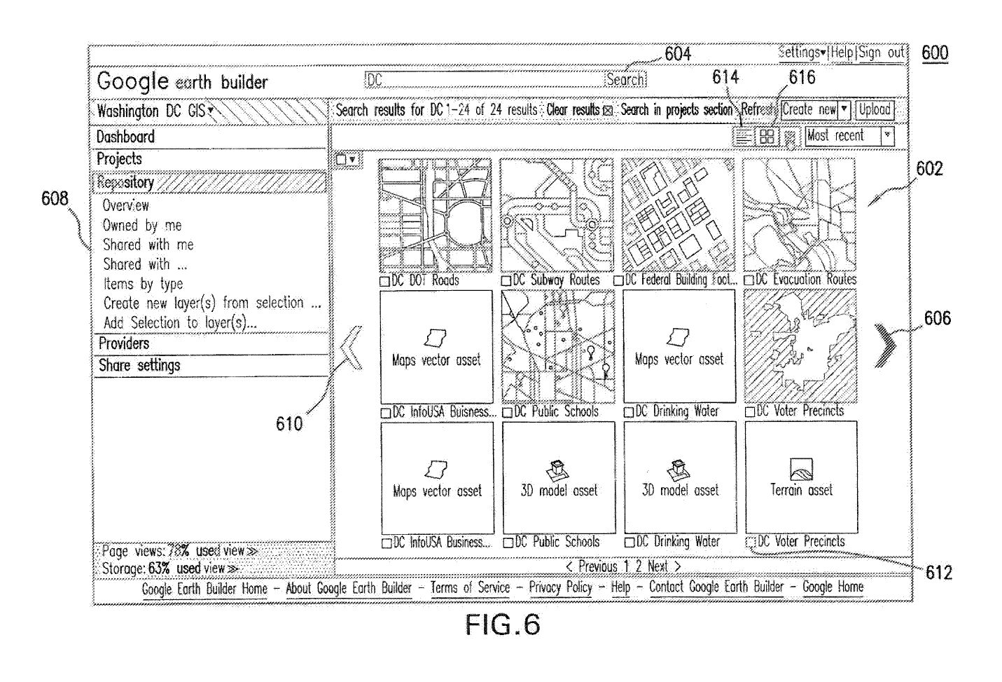

FIG. 6 illustrates an exemplary user interface 600, according to an embodiment. User interface 600 may be used to display one or more homogeneous images (e.g., thumbnail images or screen-shots),where each image represents a GIS dataset comprising one or more map assets.

User interface 600 may enable browsing of GIS datasets and map assets using displayed homogeneous images independent of underlying data formats of the GIS datasets. User interface 600 may also enable a map builder to interact with the displayed images and display metadata associated with the map assets upon user interaction with the images.

In this way, map builders can conveniently and efficiently browse and manipulate numerous heterogeneous GIS datasets that may have different underlying source formats using user interface 600 that displays images representing the datasets.

User interface 600 includes images 602 which are, for example, homogeneous thumbnail images,. Each thumbnail image may represent a GIS dataset (e.g., DC DOT roads, DC subway rotes, DC Public Schools, etc.)

A map builder may select browsing arrows 606 and 610 to scroll through other GIS datasets that may not be presently displayed. As an example, selection of browsing arrow 606 causes new thumbnail images representing other GIS datasets to be displayed. A map builder may use menu 608 to identify datasets that are owned by the map builder, shared with the map builder, shared by the map builder with other users, etc. A map builder may also use menu 608 to begin creating map layers that are to be displayed at clients 160A-N. Check boxes (e.g., check box 612) may be used to add one or more datasets to a map that is to be displayed at clients 160A-N. A map builder may use button 614 to display GIS datasets as a textual list. Button 616 may be used to display GIS datasets as homogeneous thumbnail images. Search box 604 may be used to search GIS datasets and any map related metadata, imagery, video, audio, etc. A map builder may be able to enter any search string to locate and retrieve GIS datasets (and any other map data) that may be of interest to the map builder.

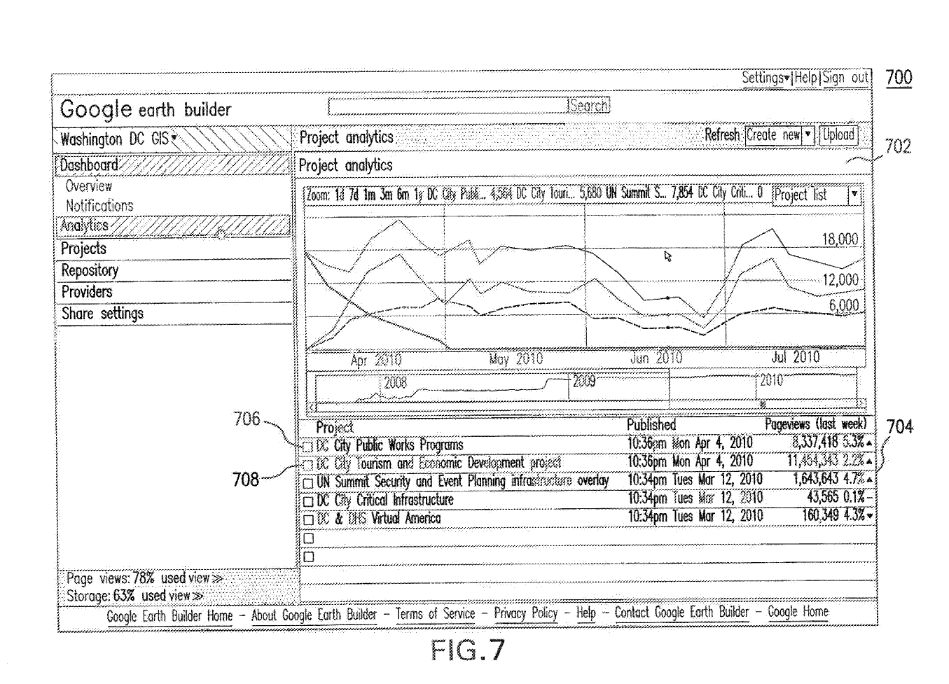

FIG. 7 illustrates an exemplary user interface 700, according to an embodiment. User interface 700 includes project analytics area 702 and 704.

Project analytics area 702 may be used to display one or more graphs (or any other visualization) associated with usage (or any other parameter) of a GIS dataset. Each graph may be associated with a different dataset. For example, graph 710 may be associated with the “DC Public Works Program” dataset and graph 712 may be associated with the “DC and DHS Virtual America” dataset. As an example, each graph may be displayed in a distinct color to enable a user to distinguish between the graphs. A user may scroll through the graphs to determine how a parameter represented by a graph changes over time (or with respect to any other parameter).

Project analytics area 704 may display a listing of GIS datasets for which analytics and metrics are available. A map builder may use checkboxes (e.g., checkboxes 706 and 708) to select datasets of interest and graphically display their analytics and metrics in project analytics area 702.

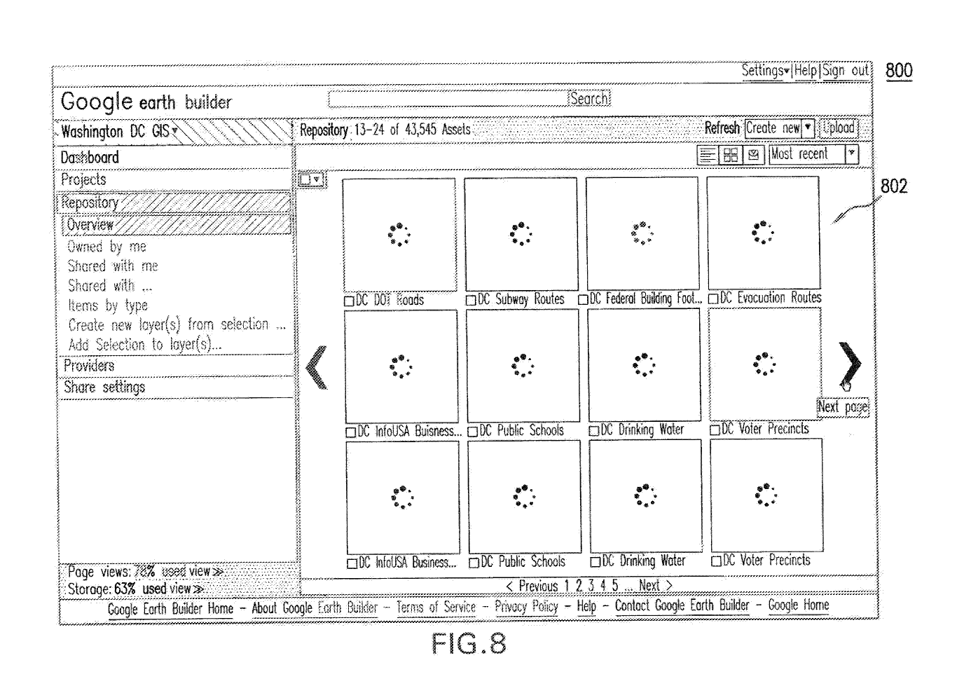

FIG. 8 illustrates an exemplary user interface 800, according to an embodiment. User interface 800 illustrates a plurality of homogeneous thumbnail images as they are being updated. Images may be updated when, for example, their corresponding GIS datasets are also updated at their respective sources.

In an embodiment, user interface 800 updates the displayed images based on updates to map assets and GIS datasets received by map data engine 120 from processing system 140. As an example, the GIS datasets may be updated at their respective sources, at clients 160A-N or even at map builder client 110. These updates may be reflected on-the-fly in their respective thumbnail images displayed on user interface 800.

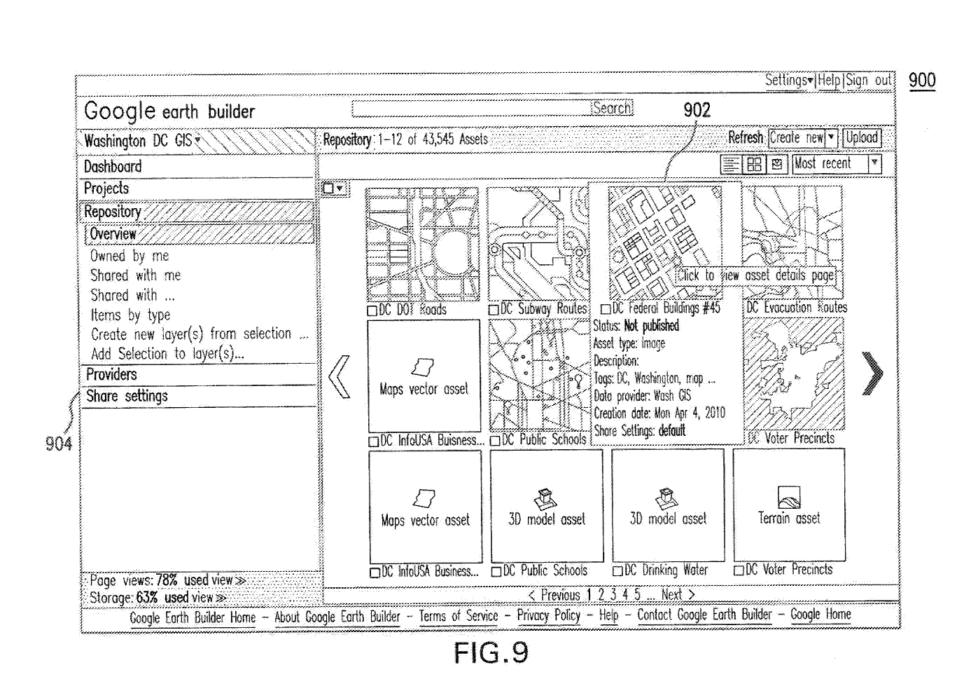

FIG. 9 illustrates an exemplary user interface 900, according to an embodiment. As an example, user interface 900 may detect a mouse click event or even a mouse hover over event on one or more images.

User interface 900 displays metadata 902 associated with a GIS dataset (e.g., “DC Federal Buildings #45”), and responsive to a mouse click or mouse hover over event on an image representing the GIS dataset.

As an example, GIS dataset metadata 902 may include, but is not limited to, map publication status (e.g., published or not published to clients 160A-N), map asset type (e.g., image), dataset description, and tags (e.g., DC, Washington, etc.). Tags may be used by a search module in processing engine 140 to retrieve and identify GIS datasets that have tags matching search queries. In addition, metadata 902 may also display the name of the dataset provider (e.g., Wash GIS), creation date and share settings that have been set by a map builder using menu 904. Share settings enable a map builder to share map projects and GIS datasets with other users and map builders.

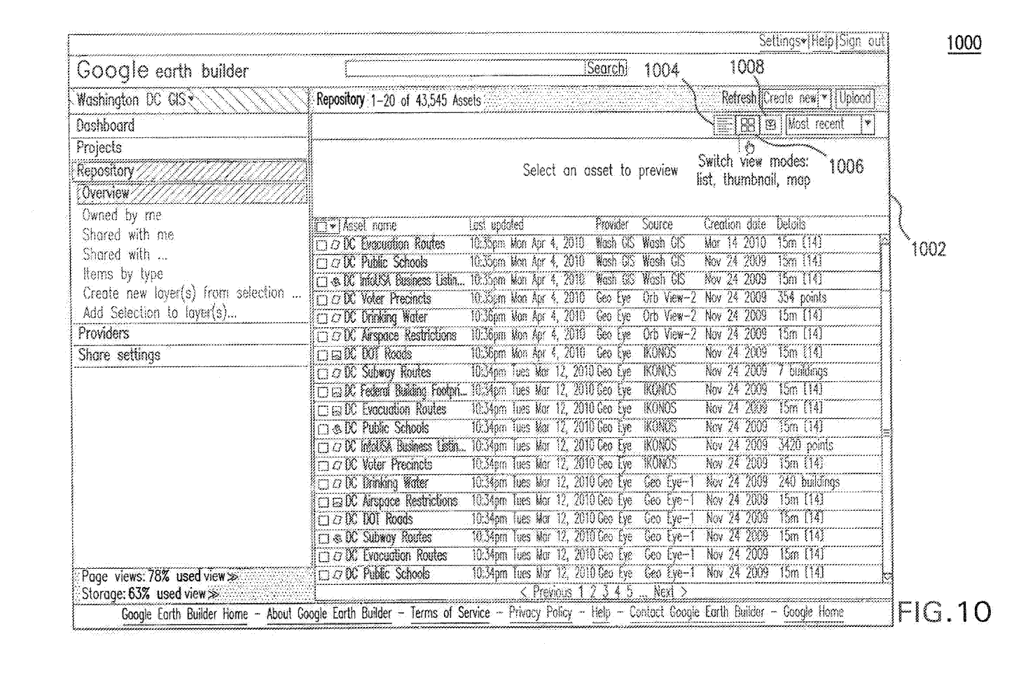

FIG. 10 illustrates an exemplary user interface 1000, according to an embodiment.

User interface 1000 illustrates list view 1002 of GIS datasets that are accessible to a map builder. As an example, list view 1002 may be obtained by selecting list view button 1004. A map builder may be able to revert back to a homogeneous thumbnail view representation (as shown in user interface 600) by selecting thumbnail view button 1006. A map view may be displayed using map view button 1008. In a map view, each dataset is represented by either the dataset's bounding box (or area) or even by a sampling of data within the dataset on a map. List view 1002 may represent each dataset as a line item and may include one or more of a GIS asset name, a last update date and time, provider name, provider source, creation date and any other details associated with a GIS dataset. A user may be able to sort datasets in list view 1002 by clicking on the name of any column (e.g., “Asset Name”, “Last Updated,” etc.)

### Example Computer Embodiment

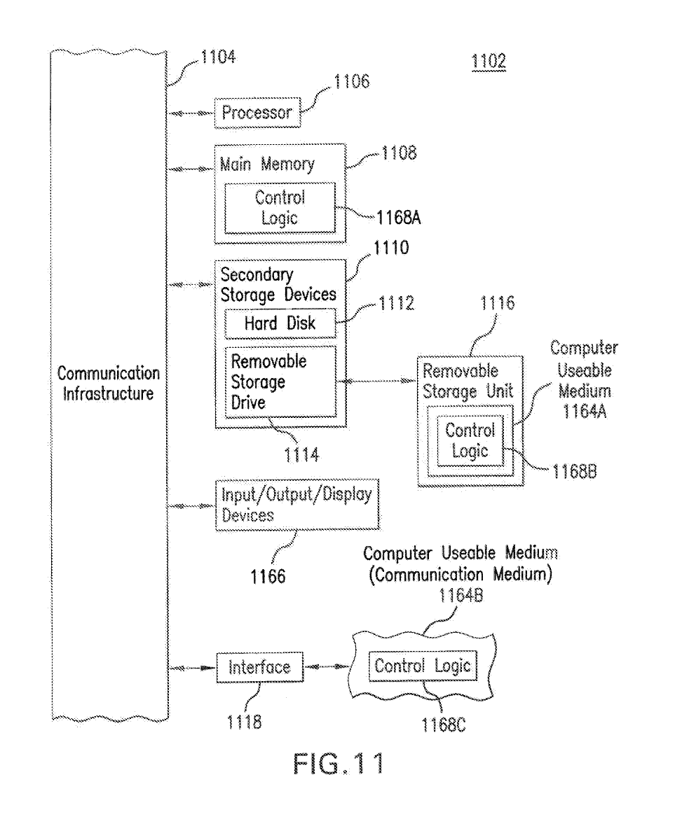

In an embodiment, the system and components of embodiments described herein are implemented using well known computers, such as example computer 1102 shown in FIG. 11. For example, map builder client 110, processing system 140, serving system 150 and client platforms 160A-N may be implemented using computer(s) 1102.

Computer 1102 can be any commercially available and well known computer capable of performing the functions described herein, such as computers available from International Business Machines, Apple, Sun, HP, Dell, Compaq, Cray, etc. Computer 1102 can also be any commercially available and well known tablet, mobile device or smart-phone capable of performing the functions described herein, such as devices available from Apple, HTC, RIM, Nokia, Sony, etc.

Computer 1102 may include one or more processors (also called central processing units, or CPUs), such as a processor 1106. Processor 1106 may be connected to a communication infrastructure 1104.

Computer 1102 may also include a main or primary memory 1108, such as random access memory (RAM). Primary memory 1108 may have stored therein control logic 1108A (computer software), and data.

Computer 1102 may also include one or more secondary storage devices 1110. Secondary storage devices 1110 may include, for example, a hard disk drive 1112 and/or a removable storage device or drive 1114, as well as other types of storage devices, such as memory cards and memory sticks. Removable storage drive 1114 represents a floppy disk drive, a magnetic tape drive, a compact disk drive, an optical storage device, tape backup, etc.

Removable storage drive 1114 may interact with a removable storage unit 1116. Removable storage unit 1116 may include a computer useable or readable storage medium 1120 having stored therein computer software 1122 (control logic) and/or data. Removable storage unit 1116 may represent a floppy disk, magnetic tape, compact disk, DVD, optical storage disk, or any other computer data storage device. Removable storage drive 1114 may read from and/or write to removable storage unit 1116 in a well-known manner

Computer 1102 may also include input/output/display devices 1124, such as monitors, keyboards, pointing devices, Bluetooth devices, etc.

Computer 1102 may further include a communication or network interface 1118. Network interface 1118 may enable computer 1102 to communicate with remote devices. For example, network interface 1118 may allow computer 1102 to communicate over communication networks or mediums 1128 (representing a form of a computer useable or readable medium), such as LANs, WANs, the Internet, etc. Network interface 1118 may interface with remote sites or networks via wired or wireless connections.

Control logic 1126 may be communicated to and from computer 1102 via communication medium 1128.

Any tangible apparatus or article of manufacture comprising a computer useable or readable medium having control logic (software) stored therein is referred to herein as a computer program product or program storage device. This may include, but is not limited to, computer 1102, main memory 1108, secondary storage devices 1110. Such computer program products, having control logic stored therein that, when executed by one or more data processing devices, cause such data processing devices to operate as described herein, represent the embodiments.

Embodiments can work with software, hardware, and/or operating system implementations other than those described herein. Any software, hardware, and operating system implementations suitable for performing the functions described herein can be used. Embodiments may be applicable to both a client and to a server or a combination of both.

The Summary and Abstract sections may set forth one or more but not all exemplary embodiments as contemplated by the inventor(s), and thus, are not intended to limit the embodiments and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments—that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method for browsing heterogeneous map data, comprising:
displaying a plurality of homogeneous images, each image representing a geographic information system (GIS) dataset comprising one or more map assets; and
enabling browsing of GIS datasets and map assets using said displayed images independent of underlying data formats of said GIS datasets,
wherein said displaying and said enabling are performed using one or more processors.

2. The method of claim 1, wherein said displaying comprises displaying uniform thumbnail images representing said GIS datasets.

3. The method of claim 2, further comprising:
enabling a user to interact with said images; and
displaying metadata associated with said map assets upon user interaction with said images.

4. The method of claim 3, further comprising:
enabling searching of map assets based on said metadata.

5. The method of claim 1, further comprising:
displaying metrics and analytics related to usage of said map assets; and
enabling user interaction with said metrics and analytics.

6. The method of claim 1, further comprising:
enabling creation of one or more workspaces, said workspaces comprising one or more of said map assets from said GIS datasets; and
enabling manipulation of said map assets using said workspaces.

7. The method of claim 3, farther comprising:
displaying said metadata as a list; and
enabling sorting of said list by one or more of a map asset name, a map asset update date, a map asset source and a map asset creation date.

8. The method of claim 1, further comprising:
updating one or more of said images, when map assets in GIS datasets represented by said one or more images are updated.

9. The method of claim 1, further comprising:
enabling creation of layered maps by enabling selection of map assets using said displayed images.

10. The method of claim 1, further comprising:
enabling a user to share one or more map assets with other users.

11. The method of claim 1, further comprising:
enabling a user to select providers of said GIS datasets.

12. A computer-based system for browsing heterogeneous map data, comprising:
one or more processors;
a map data engine configured to receive a plurality of homogeneous images, each image representing a geographic information system (GIS) dataset comprising one or more map assets; and
a user interface configured to display said images and enable browsing of GIS datasets and map assets using said displayed images independent of underlying data formats of said GIS datasets,
wherein said map data engine and said user interface are implemented using said one or more processors.

13. The system of claim 12, wherein said user interface is configured to display uniform thumbnail images representing said GIS datasets.

14. The system of claim 12, wherein said user interface is configured to enable a user to interact with said images and display metadata associated with said map assets upon user interaction with said images.

15. The system of claim 14, wherein said user interface is configured to enable searching of map assets based on said metadata.

16. The system of claim 12, wherein said user interface is configured to display metrics and analytics related to usage of said map assets, and enable user interaction with said metrics and analytics.

17. An article of manufacture including a computer-readable medium having instructions stored thereon that, when executed by a computing device, cause said computing device to perform operations comprising:
displaying a plurality of homogeneous images, each image representing a geographic information system (GIS) dataset comprising one or more map assets; and
enabling browsing of GIS datasets and map assets using said displayed images independent of underlying data formats of said GIS datasets,
wherein said displaying and said enabling are performed using one or more processors.

18. The article of manufacture of claim 17, wherein said displaying comprises displaying uniform thumbnail images representing said GIS datasets.

19. The article of manufacture of claim 18, said operations further comprising:
enabling a user to interact with said images; and
displaying metadata associated with said map assets upon user interaction with said images.

20. The article of manufacture of claim 19, said operations further comprising:
enabling searching of map assets based on said metadata.
